(19) United States
(12) Patent Application Publication
(10) Pub. No.: US 2026/0120446 A1
(43) Pub. Date: Apr. 30, 2026

(54) DEVICE AND METHOD WITH MULTI-MODAL FEATURE FUSION

(71) Applicant: SAMSUNG ELECTRONICS CO., LTD., Suwon-si (KR)

(72) Inventors: Xiaoshuai HAO, Beijing (CN); Chao ZHANG, Beijing (CN); Hui ZHANG, Beijing (CN); Weiming LI, Beijing (CN); Mengchuan WEI, Beijing (CN)

(73) Assignee: SAMSUNG ELECTRONICS CO., LTD., Suwon-si (KR)

(21) Appl. No.: 19/230,459

(22) Filed: Jun. 6, 2025

(30) Foreign Application Priority Data
Oct. 29, 2024 (CN) 202411520954.5
Mar. 12, 2025 (KR) 10-2025-0032036

(51) Int. Cl. G06V 10/80; G06V 10/77; G06V 20/56

(52) U.S. Cl. CPC G06V 10/806; G06V 10/7715; G06V 20/56

(57) ABSTRACT

A method executed by an electronic device includes: obtaining a first modal feature extracted from an image obtained through one or more first sensors and obtaining a second modal feature extracted from a point cloud obtained through a second sensor that has different modality that that of the one or more first sensors; obtaining a first augmented feature by performing feature augmentation processing on the first modal feature using the second modal feature; obtaining a second augmented feature by performing feature augmentation processing on the second modal feature using the first modal feature; obtaining a fused feature by fusing the first augmented feature with the second augmented feature; and performing a target task using the obtained fused feature.

### CROSS-REFERENCE TO RELATED APPLICATIONS

This application claims the benefit under 35 USC § 119 (a) of Chinese Patent Application No. 202411520954.5 filed on Oct. 29, 2024, in the China National Intellectual Property Administration, and Korean Patent Application No. 10-2025-0032036 filed on Mar. 12, 2025, in the Korean Intellectual Property Office, the entire disclosures of which are incorporated by reference herein for all purposes.

### BACKGROUND

### 1. Field

The following description relates to an electronic device and a method with multi-modal feature fusion.

### 2. Description of Related Art

A multi-modal feature fusion technique may be used for tasks such as map building and target detection. Multi-modal data includes different types of data, and multi-modal features represent features extracted from multi-modal data. To improve the consistency of meanings represented by multi-modal features, multi-modal features obtained from a machine learning model may be fused, or multi-modal data may be fused and input to a machine learning model for extracting features.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electronic device includes one or more processors and a memory storing instructions configured to, when executed by the one or more processors, cause the electronic device to: obtain a first modal feature extracted from an image obtained through one or more first sensors and obtain a second modal feature extracted from a point cloud obtained through a second sensor that has a different modality than that of the one or more first sensors; obtain a first augmented feature by performing feature augmentation processing on the first modal feature using the second modal feature and obtain a second augmented feature by performing feature augmentation processing on the second modal feature using the first modal feature; obtain a fused feature by fusing the first augmented feature with the second augmented feature; and perform a target task using the obtained fused feature.

The instructions may be further configured to cause the electronic device to: obtain, from a first feature augmentation model, the first augmented feature by augmenting the first modal feature, wherein the first feature augmentation model receives, as inputs, the first modal feature and a second query, which is obtained from a second feature mapping layer of a second feature augmentation model; and obtain, from the second feature augmentation model, the second augmented feature by augmenting the second modal feature, wherein the second feature augmentation model receives, as inputs, the second modal feature and a first query, which is output from a first feature mapping layer of the first feature augmentation model.

The first feature augmentation model may include: the first feature mapping layer configured to extract, from the first modal feature, an input of a first attention layer; and the first attention layer configured to output a feature based on the first modal feature and the second modal feature, and wherein the instructions are further configured to cause the electronic device to: obtain, from the first feature mapping layer receiving the first modal feature as an input, a first key and a first value that are used in the first attention layer; obtain the second query from the second feature mapping layer receiving the second modal feature as an input; obtain a first feature from the first attention layer receiving the second query, the first key, and the first value as inputs; and obtain the first augmented feature based on the first feature and the second query.

The first feature augmentation model may further include: a first normalization layer configured to normalize an output of the first attention layer; and a first multi-layer perceptron layer connected with the first normalization layer, and the instructions may be further configured to cause the electronic device to: obtain a second feature from the first normalization layer receiving the first feature and the second query as inputs; obtain a third feature from the first multi-layer perceptron layer receiving the second feature as an input; and obtain the first augmented feature from a second normalization layer receiving the second feature and the third feature as inputs.

The second feature augmentation model may include: a second feature mapping layer configured to extract, from the second modal feature, an input of a second attention layer; and the second attention layer may be configured to output a feature based on the second modal feature and the first modal feature, and the instructions may be further configured to cause the electronic device to: obtain, from the second feature mapping layer receiving the second modal feature as an input, a second key and a second value that may be used in the second attention layer; obtain the first query from the first feature mapping layer receiving the first modal feature as an input; obtain a fourth feature from the second attention layer receiving the first query, the second key, and the second value as inputs; and obtain the second augmented feature based on the fourth feature and the first query.

The second feature augmentation model may further include: a third normalization layer configured to normalize an output of the second attention layer; and a second multi-layer perceptron layer connected with the third normalization layer, and the instructions may be further configured to cause the electronic device to: obtain a fifth feature from the third normalization layer receiving the fourth feature and the first query as inputs; obtain a sixth feature from the second multi-layer perceptron layer receiving the fifth feature as an input; and obtain the second augmented feature from a fourth normalization layer receiving the fifth feature and the sixth feature as inputs.

The first feature augmentation model may include first feature augmentation sub-models, each of the first feature augmentation sub-models may include an instance of the first feature mapping layer, an instance of the first attention layer, an instance of the first normalization layer, and an instance of the first multi-layer perceptron layer, the first feature augmentation sub-models may be connected with one another in series, and both an output of a given first feature augmentation sub-model and the second query obtained from the second feature mapping layer of the second feature augmentation model may be an input of a next first feature augmentation sub-model after the given first feature augmentation sub-model.

The second feature augmentation model may include second feature augmentation sub-models, each of the second feature augmentation sub-models may include an instance of the second feature mapping layer, an instance of a second attention layer, an instance of a third normalization layer, and an instance of a second multi-layer perceptron layer, the second feature augmentation sub-models may be connected with one another in series, an output of the given first feature augmentation sub-model and a second query obtained from the second feature mapping layer of a previous second feature augmentation sub-model may be an input of the next first feature augmentation sub-model, and the given first feature augmentation sub-model may be a model corresponding to the previous second feature augmentation sub-model.

The second feature augmentation model may include second feature augmentation sub-models, each of the second feature augmentation sub-models may include an instance of the second feature mapping layer, an instance of the second attention layer, an instance of the third normalization layer, and an instance of the second multi-layer perceptron layer, the second feature augmentation sub-models may be connected with one another in series, and an output of a previous second feature augmentation sub-model and the first query obtained from the first feature mapping layer of the first feature augmentation model may be an input of a next second feature augmentation sub-model.

The first feature augmentation model may include first feature augmentation sub-models, each of the first feature augmentation sub-models may include an instance of the first feature mapping layer, an instance of a first attention layer, an instance of a first normalization layer, and an instance of a first multi-layer perceptron layer, the first feature augmentation sub-models may be connected with one another in series, an output of the previous second feature augmentation sub-model and a first query obtained from the first feature mapping layer of a previous first feature augmentation sub-model may be an input of a next second feature augmentation sub-model, and the previous second feature augmentation sub-model may be a model corresponding to the previous first feature augmentation sub-model.

A first attention layer of the first feature augmentation model may include a multi-head attention mechanism, and a second attention layer of the second feature augmentation model may include a multi-head attention mechanism.

The instructions may be further configured to cause the electronic device to obtain the fused feature from a feature fusion model based on the first augmented feature and the second augmented feature.

The instructions may be further configured to cause the electronic device to: obtain a cascaded feature by cascading the first augmented feature and the second augmented feature; obtain, from the feature fusion model receiving the cascaded feature as an input, a feature extracted from the cascaded feature; obtain sub-fused features that are used to generate the fused feature based on the extracted feature, the first augmented feature, and the second augmented feature; and obtain the fused feature by cascading the sub-fused features.

The one or more first sensors may be one or more camera sensors, and the second sensor may be a light detection and ranging (LiDAR) sensor.

In another general aspect, a method executed by an electronic device includes: obtaining a first modal feature extracted from an image obtained through one or more first sensors and obtaining a second modal feature extracted from a point cloud obtained through a second sensor that has different modality that that of the one or more first sensors; obtaining a first augmented feature by performing feature augmentation processing on the first modal feature using the second modal feature; obtaining a second augmented feature by performing feature augmentation processing on the second modal feature using the first modal feature; obtaining a fused feature by fusing the first augmented feature with the second augmented feature; and performing a target task using the obtained fused feature.

The obtaining of the first augmented feature may include obtaining, from a first feature augmentation model, the first augmented feature by augmenting the first modal feature, wherein the first feature augmentation model receives, as inputs, the first modal feature and a second query, which is obtained from a second feature mapping layer of a second feature augmentation model, and the obtaining of the second augmented feature includes obtaining, from a second feature augmentation model, the second augmented feature by augmenting the second modal feature, wherein the second feature augmentation model receives, as inputs, a first query, which is output from a first feature mapping layer of the first feature augmentation model, and the second modal feature.

The first feature augmentation model may include: the first feature mapping layer configured to extract, from the first modal feature, an input of a first attention layer; and the first attention layer configured to output a feature based on the first modal feature and the second modal feature, and wherein the obtaining of the first augmented feature may include: obtaining, from the first feature mapping layer receiving the first modal feature as an input, a first key and a first value that are used in the first attention layer; obtaining the second query from the second feature mapping layer receiving the second modal feature as an input; obtaining a first feature from the first attention layer receiving the second query, the first key, and the first value as inputs; and obtaining the first augmented feature based on the first feature and the second query.

The second feature augmentation model may include: a second feature mapping layer configured to extract, from the second modal feature, an input of a second attention layer; and the second attention layer configured to output a feature based on the second modal feature and the first modal feature, and the obtaining of the second augmented feature may include: obtaining, from the second feature mapping layer receiving the second modal feature as an input, a second key and a second value that are used in the second attention layer; obtaining the first query from a first feature mapping layer receiving the first modal feature as an input; obtaining a fourth feature from the second attention layer receiving the first query, the second key, and the second value as inputs; and obtaining the second augmented feature based on the fourth feature and the first query.

In another general aspect, a vehicle system includes: one or more first sensors configured to obtain an image of a target zone; a second sensor configured to obtain a point cloud for the target zone; a memory in which instructions are stored; and one or more processor configured to execute the instructions stored in the memory, wherein the instructions, when executed by the one or more processors, cause the vehicle system to: obtain a first modal feature extracted from an image obtained through the one or more first sensors and obtain a second modal feature extracted from a point cloud obtained through the second sensor that has a different modality than that of the one or more first sensors; obtain a first augmented feature by performing feature augmentation processing on the first modal feature using the second modal feature and obtain a second augmented feature by performing feature augmentation processing on the second modal feature using the first modal feature; obtain a fused feature by fusing the first augmented feature with the second augmented feature; and control the vehicle system to perform a target task using the obtained fused feature.

The instructions, when executed by the one or more processors, may cause the vehicle system to: obtain, from a first feature augmentation model, the first augmented feature by augmenting the first modal feature, wherein the first feature augmentation model receives, as inputs, the first modal feature and a second query, which may be obtained from a second feature mapping layer of a second feature augmentation model; and control the vehicle system to obtain, from a second feature augmentation model, the second augmented feature by augmenting the second modal feature, wherein the second feature augmentation model may receive, as inputs, a first query, which is output from a first feature mapping layer of the first feature augmentation model, and the second modal feature.

Other features and aspects will be apparent from the following detailed description, the drawings, and the claims.

### BRIEF DESCRIPTION OF THE DRAWINGS

FIG. 1 illustrates an example of methods performed by an electronic device, according to one or more embodiments.

FIG. 2 illustrates an example of obtaining an augmented feature, according to one or more embodiments.

FIG. 3 illustrates an example of fusing augmented features, according to one or more embodiments.

FIG. 4 illustrates an example in which an electronic device is used for map building, according to one or more embodiments.

FIG. 5 illustrates an example of components of an electronic device, according to one or more embodiments.

FIG. 6 illustrates an example of connections between components of an electronic device, according to one or more embodiments.

FIG. 7 illustrates an example of a vehicle system using an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

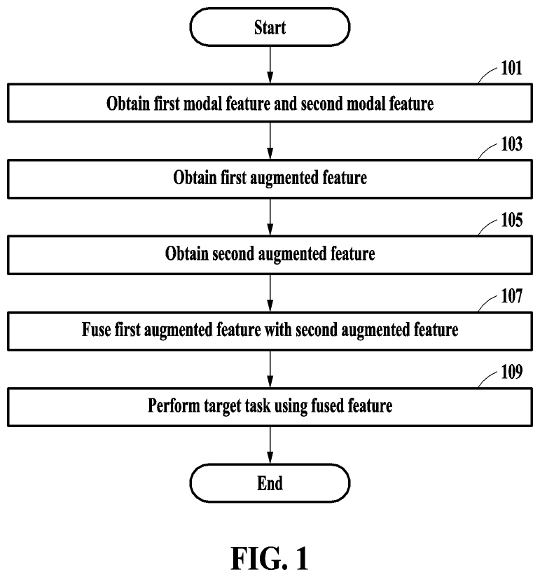

FIG. 1 illustrates an example of methods performed by an electronic device, according to one or more embodiments.

A method of fusing multi-modal features (e.g., features extracted from an image and features extracted from a point cloud) may be used for a map building task, for example. An image may be data, for example visual/camera data, in a two-dimensional (2D) space, and a feature extracted from an image may be a feature of data expressed in a 2D space. A point cloud may be a set of points arranged in a 3D space, and a feature extracted from the point cloud may be a feature of set of points. Although point clouds and images are two respective example modalities described herein, the methods and techniques described herein may be applied to modalities of any types of data.

A map building task may be performed based on a technique of predicting a map element from a bird's eye view (BEV). A map element may represent an element included in a map (e.g., a crosswalk, a lane divider, and a road boundary). A map element may be expressed as a vector representation or a mask representation, for example. A vector representation may represent map elements as respective curves, b-spline curves, segmented polylines (a line representing a connecting line between landmark coordinates and a landmark), or the like. A vector map generated based on vector representation may be referred to as a high-definition map or a vector image. A mask representation be a mask applied to a region including a map element. A map generated based on mask representation may be referred to as a semantic map.

When a map is used for autonomous driving of a vehicle, it may be required that the provides rich and precise information about the driving environment of the vehicle. A map used for autonomous driving of a vehicle may be built (or generated) based on the fusion of features of different modalities. A multi-modal feature may be a feature extracted from a result obtained when an image and a point cloud are mapped to a space representing the same BEV viewpoint.

A map built based on existing multi-modal feature fusion methods may not provide precise information about the driving environment of a vehicle because meanings indicated by multi-modal features are not consistent due to differences between the features of different respective modalities. Existing multi-modal feature fusion methods include: a method of cascading extracted different modal features and obtaining fused features from a machine learning model receiving the cascaded features as inputs; a synthetic multi-modal feature fusion method that fuses the features extracted from the machine learning model receiving different pieces of extracted modal data as inputs; and a dynamic multi-modal feature fusion method that extracts fused features by performing cascade and convolution on the extracted different modal features and selects important fused features among the extracted fused features using an attention mechanism.

With existing multi-modal feature fusion methods, the meaning of multi-modal data may not be consistent due to (i) differences in the data types of images and point clouds and (ii) direct arithmetic operations or concatenations of multi-modal features. Additionally, simply cascading or concatenating different modal features used in existing multi-modal feature fusion methods may result in loss of information included in features of the different modalities. Therefore, a map built based on existing multi-modal feature fusion methods may not provide driving environment information with the precision usually required for autonomous driving of a vehicle due to meaning inconsistencies between features of different modalities and loss of information included in the modal features. Unless the context suggests otherwise, “modal feature”, as used herein, refers to features of different respective modalities, e.g., an image feature and a point cloud feature may be referred to as modal feature. In the following description, “first modal feature” refers to a feature of a first modality, and “second modal feature” refers to a feature of a second modality.

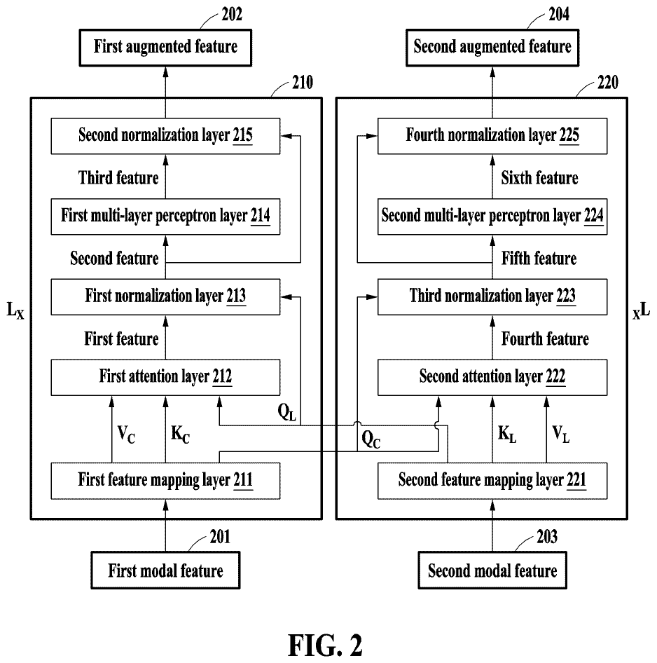

Unlike existing multi-modal feature fusion methods, various implementations and examples of an electronic device 500 proposed in the present disclosure may input modal features of a given modality to a feature augmentation model (e.g., a first feature augmentation model 210 of FIG. 2) that corresponds to the given modality and obtain, from the feature augmentation model, augmented features (e.g., a first augmented feature 202 of FIG. 2), which are the augmented modal features (augmented features of the given modality). The feature augmentation model (e.g., the entire model shown in FIG. 2) may be a machine learning model that augments input multi-modal features. Augmenting a first modal feature, for example, may involve adaptively selecting information that is useful for performing a target task from a second modal feature (e.g., the second modal feature 203 of FIG. 2), which is extracted from second modal data, rather than the first modal feature (e.g., first modal feature 201 of FIG. 2) and supplementing (including changing and adding) the first modal feature with the selected information. Conversely, augmenting a second modal feature may involve adaptively selecting information that is useful for performing a target task from the first modal feature, which is extracted from first modal data, rather than the second modal feature and supplementing (including changing and adding) the second modal feature based on the selected information. The fusing of multi-modal features based on a feature augmentation method may increase the consistency of meanings between different features of different modalities and improve the performance accuracy of a target task (e.g., a map building task).

Referring to FIG. 1, in operation 101, an electronic device may obtain a first modal feature and a second modal feature. The electronic device may obtain the first modal feature by, for example, extracting the first modal feature from an image obtained through a first sensor and obtain the second modal feature by, for example, extracting the second modal feature from a point cloud obtained through a second sensor. The first sensor may be a camera sensor, and the second sensor may be a light detection and ranging (LiDAR) sensor.

The image obtained through the first sensor may be an image of a target object (e.g., a target zone for map building), and the image obtained through the second sensor may be a point cloud of a target object (e.g., a target zone for map building). For example, the image obtained through the first sensor may be an image obtained from a red-green-blue (RGB) camera mounted on a vehicle, and the point cloud obtained through the second sensor may be a point cloud obtained from a LIDAR sensor mounted on the vehicle.

The first modal feature may be a feature extracted from a converted image obtained by converting a viewpoint (e.g., a pose of the RGB camera) of a captured image (e.g. captured by the RGB camera) into a BEV viewpoint, and the second modal feature may be a feature extracted from a converted point cloud obtained by converting a viewpoint (e.g., a pose of the LiDAR sensor) of a captured point cloud (e.g., captured by the LiDAR) into a BEV viewpoint.

In operation 103, the electronic device may obtain a first augmented feature.

The electronic device may obtain the first augmented feature by performing feature augmentation processing on the first modal feature based on the second modal feature. The feature augmentation processing may be referred to as multi-directional cross-modal interactive transformation. Although examples herein describe two modalities and two modal features, there may be three or more modal features. For example, modal features may include a first modal feature, a second modal feature, and a third modal feature. In this case, augmentation processing performed on the first modal feature may be based on the second modal feature and the third modal feature. Augmentation processing performed on the second modal feature may be based on the first modal feature and the third modal feature. Augmentation processing performed on the third modal feature may be based on the first modal feature and the second modal feature.

For example, the electronic device may obtain, from a first feature augmentation model (e.g., a first feature augmentation model 210 of FIG. 2), the first augmented feature by augmenting the first modal feature, wherein the first feature augmentation model receives, as inputs, the first modal feature and a second query. The second query may be a vector used to find a correlation between pieces of information included in the modal features in a cross-attention process between the first modal feature and the second modal feature.

The first feature augmentation model may include a first feature mapping layer and a first attention layer. The first feature mapping layer may extract, from the first modal feature, an input of the first attention layer included in the first feature augmentation model. The first attention layer may output a first feature based on the first modal feature and the second modal feature. The first attention layer may be based on a multi-head attention mechanism. The multi-head attention mechanism may have attention layers and that process in parallel.

The electronic device may obtain, from the first feature mapping layer (and based on the first modal feature as an input), a first key and a first value that are used in a first attention layer. The electronic device may obtain a second query from a second feature mapping layer (e.g., in a second feature augmentation model 220 of FIG. 2) based on receiving the second modal feature as an input. A key may be a characteristic of an input modal feature and may be used to determine the importance of a query by calculating a similarity (e.g., dot product or cosine similarity) to a query. The query may be a vector used to find a correlation between pieces of information included in the respective modal features in a cross-attention process between the first modal feature and the second modal feature. A value may be a weight applied to a similarity calculation result (e.g., attention score) between a query and a key and may be used to generate an output value of an attention layer (see, e.g., “first feature” and “fourth feature” in FIG. 2). The electronic device may obtain a first feature from the first attention layer receiving the second query, the first key, and the first value as inputs. For example, the electronic device may obtain an attention score by performing a similarity calculation on the second query and the first key and obtain the first feature by applying the first value to the attention score. The electronic device may obtain the first augmented feature based on the first feature and the second query. For example, the electronic device may output a result of normalizing the first feature using the second query as the first augmented feature.

The first feature augmentation model may further include a first normalization layer that normalizes the output of the first attention layer and a first multi-layer perceptron layer connected to the first normalization layer. The first normalization layer may be a layer that adjusts data distribution of the first feature using a statistical value of the second query (e.g., a mean and/or variance of the second query). The first multi-layer perceptron layer may be a layer that extracts a feature (e.g., a third feature) for input data by transforming the input data (e.g., a second feature). In general, a multi-layer perceptron layer may include a hidden layer, and the hidden layer may include fully connected layers. The multi-layer perceptron layer may generate a final output value by expanding the dimension of the input data, by applying a nonlinear transformation to the expanded input data, and by reducing the dimension of the input data with the nonlinear transformation applied to the original dimension.

Through the above process, the electronic device may obtain the second feature from the first normalization layer (per it receiving the first feature and the second query as inputs) and obtain the third feature from the first multi-layer perceptron layer (per it receiving the second feature as an input). The electronic device may obtain the first augmented feature from a second normalization layer (per it receiving the second feature and the third feature as inputs). The second normalization layer may be similar to the first normalization layer in terms of structure and function (although weights or the like may vary). The second normalization layer may be a layer that adjusts data distribution of the third feature using a statistical value of the second feature (e.g., a mean and/or variance of the second feature).

The first feature augmentation model may include multiple first feature augmentation sub-models. Each of the first feature augmentation sub-models may include its own instances of the first feature mapping layer, the first attention layer, the first normalization layer and the first multi-layer perceptron layer; the first feature augmentation sub-models may be connected with one another in series. An (i) output of a previous first feature augmentation sub-model and (ii) the second query obtained from a second feature mapping layer of a second feature augmentation model may both be an input of a next first feature augmentation sub-model. Similarly, the second feature augmentation model may include multiple second feature augmentation sub-models. Each of the second feature augmentation sub-models may include its own instances of the second feature mapping layer, a second attention layer, a third normalization layer and a second multi-layer perceptron layer; the second feature augmentation sub-models may be connected to one another in series. The (i) output of the previous first feature augmentation sub-model and (ii) the second query obtained from the second feature mapping layer of a previous second feature augmentation sub-model may both be an input of the next first feature augmentation sub-model, and the previous first feature augmentation sub-model may be a model corresponding to the previous second feature augmentation sub-model. To summarize, the first feature augmentation model may include the multiple first feature augmentation sub-models, and the second feature augmentation model may include multiple second feature augmentation sub-models, as described in more detail with reference to FIG. 2.

In operation 105, the electronic device may obtain a second augmented feature.

The electronic device may obtain the second augmented feature by performing feature augmentation processing on the second modal feature by using the first modal feature. As in operation 103, this feature augmentation processing may also be referred to as multi-directional cross-modal interactive transformation.

For example, the electronic device may obtain, from the second feature augmentation model, the second augmented feature by augmenting the second modal feature, wherein the second feature augmentation model receives the second modal feature and the first query as inputs. The first query may be a vector used to find a correlation between pieces of information included in the modal features in a cross-attention process between the first modal feature and the second modal feature.

The electronic device may obtain, from the second feature augmentation model, the second augmented feature by augmenting the second modal feature, wherein the second feature augmentation model receives the first query and the second modal feature as inputs. The first query may be output from the first feature mapping layer of the first feature augmentation model.

The second feature augmentation model may include the second feature mapping layer and the second attention layer. The second feature mapping layer may extract an input of the second attention layer from the second modal feature. The second attention layer may output a feature based on the second modal feature and the first modal feature. The second attention layer may be an attention layer based on a multi-head attention mechanism. The second feature mapping layer and the second attention layer correspond, functionally, to the first feature mapping layer and the second attention layer, respectively.

The electronic device may obtain, from the second feature mapping layer, a second key and a second value that are used in the second attention layer; the second feature mapping layer receives the second modal feature as an input. The electronic device may obtain the first query from the first feature mapping layer receiving the first modal feature as an input. The electronic device may obtain a fourth feature from the second attention layer receiving the first query, the second key, and the second value as inputs. For example, the electronic device may obtain an attention score by performing a similarity calculation on the first query and the second key and obtain the fourth feature by applying the second value to the attention score. The electronic device may obtain the second augmented feature based on the fourth feature and the first query. For example, the electronic device may output a result of normalizing the fourth feature using the first query as the second augmented feature.

The second feature augmentation model may further include the third normalization layer that normalizes the output of the second attention layer and the second multi-layer perceptron layer connected to the third normalization layer. The third normalization layer may be a layer that adjusts data distribution of the fourth feature using a statistical value of the first query (e.g., a mean and/or variance of the first query). The second multi-layer perceptron layer may be a layer that extracts a feature (e.g., a sixth feature) for input data by transforming the input data (e.g., a fifth feature). The second multi-layer perceptron layer is functionally similar to the first multi-layer perceptron layer (albeit with different weights or other parameters).

Through the above process, the electronic device may obtain the fifth feature from the third normalization layer based on the third layer receiving the fourth feature and the first query as inputs and obtain the sixth feature from the second multi-layer perceptron layer receiving the fifth feature as an input. The electronic device may obtain the second augmented feature from a fourth normalization layer receiving the fifth feature and the sixth feature as inputs. The fourth normalization layer may be similar to the third normalization layer. The fourth normalization layer may be a layer that adjusts data distribution of the sixth feature using a statistical value of the fifth feature (e.g., a mean and/or variance of the fifth feature).

The second feature augmentation model may include multiple second feature augmentation sub-models. Each of the second feature augmentation sub-models may include its own instances of the second feature mapping layer, the second attention layer, the third normalization layer, and the second multi-layer perceptron layer, and the second feature augmentation sub-models may be connected with one another in series.

An output of a previous second feature augmentation sub-model and the first query obtained from the first feature mapping layer of the first feature augmentation model may be an input of a next second feature augmentation sub-model. The second feature augmentation model may include multiple second feature augmentation sub-models. Each of the second feature augmentation sub-models may include its own instances of the second feature mapping layer, a second attention layer, a third normalization layer, and a second multi-layer perceptron layer. The second feature augmentation sub-models may be connected with one another in series. The output of the previous second feature augmentation sub-model and the first query obtained from the first feature mapping layer of the previous first feature augmentation sub-model may be inputs of the next second feature augmentation sub-model, and the second feature augmentation sub-model may be a model corresponding to the previous first feature augmentation sub-model. The first feature augmentation model may include the first feature augmentation sub-models, and the second feature augmentation model may include the second feature augmentation sub-models, as described in more detail with reference to FIG. 2.

In operation 107, the electronic device may fuse the first augmented feature with the second augmented feature.

The electronic device may obtain a fused feature by fusing the first augmented feature with the second augmented feature. The electronic device may obtain the fused feature from a feature fusion model based on the first augmented feature and the second augmented feature.

The electronic device may obtain a cascaded feature by cascading the first augmented feature and the second augmented feature. The electronic device may obtain a feature extracted from the cascaded feature from the feature fusion model receiving the cascaded feature as an input. For example, the electronic device may obtain, from the feature fusion model receiving the cascaded feature as an input, a feature extracted by performing a convolution operation on the cascaded feature or by applying a sigmoid function to the cascaded feature. The convolution operation may extract a predetermined feature by applying a filter (or kernel) to input data. The sigmoid function may be a nonlinear function that converts an input value into a value between 0 and 1.

The electronic device may obtain sub-fused features used to generate a fused feature based on the feature extracted from the cascaded feature, the first augmented feature, and the second augmented feature. The electronic device may obtain the fused feature by cascading the sub-fused features.

The electronic device may obtain the first augmented feature based on adaptively selecting valuable information from the second modal feature rather than from the first modal feature and may obtain the second augmented feature based on adaptively selecting valuable information from the first modal feature rather than from the second modal feature. This approach may prevent an information loss issue caused by fusion of different modal features through the above process.

In operation 109, the electronic device may perform a target task using the fused feature. For example, the electronic device may perform a map building task for autonomous driving of a vehicle or an object detection task for detecting an object using the fused feature, as non-limiting examples.

FIG. 2 illustrates an example of obtaining an augmented feature, according to one or more embodiments.

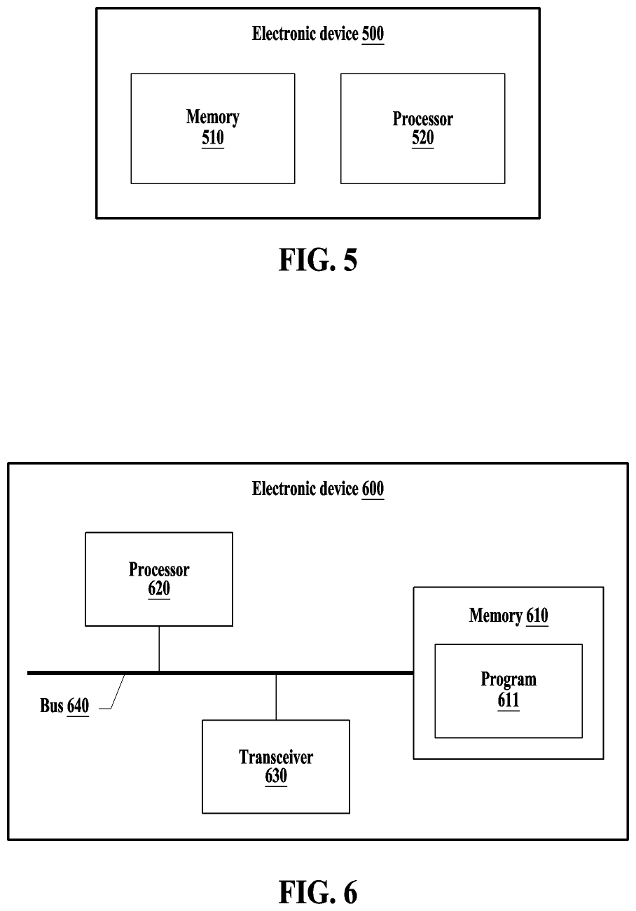

Referring to FIG. 2, an electronic device (e.g., the electronic device 500 of FIG. 5) may obtain the first augmented feature 202 by performing feature augmentation processing on the first modal feature 201 using a second modal feature 203. For example, the electronic device may obtain, from a first feature augmentation model 210, the first augmented feature 202 by augmenting the first modal feature 201, wherein the first feature augmentation model 210 receives, as inputs, the first modal feature 201 and a second query, which is obtained from a second feature mapping layer 221 of a second feature augmentation model 220.

The electronic device may obtain a second augmented feature 204 by performing feature augmentation processing on the second modal feature 203 using the first modal feature 201. For example, the electronic device may obtain, from a second feature augmentation model 220, the second augmented feature 204 by augmenting the second modal feature 203; the second feature augmentation model 220 receives, as inputs, a first query, which is output from a first feature mapping layer 211 of the first feature augmentation model 210, and the second modal feature 203. The electronic device may obtain the first modal feature 201, which may be extracted from an image obtained by converting the viewpoint of an image obtained through a first sensor into a BEV viewpoint. The electronic device may obtain the second modal feature 203, which may be extracted from a point cloud obtained by converting, into a BEV viewpoint, the viewpoint of a point cloud obtained through a second sensor that is different from the first sensor. The first sensor may be a camera sensor, and the second sensor may be a LIDAR sensor. Hereinafter, a description is provided based on an assumption that the first modal feature 201 is a feature extracted from an image having a viewpoint converted into a BEV and that the second modal feature 203 is a feature extracted from a point cloud having a viewpoint converted into a BEV.

The first feature augmentation model 210 may include the first feature mapping layer 211 and a first attention layer 212. The electronic device may obtain, from the first feature mapping layer 211, a first key and a first value that are used in the first attention layer 212; the first feature mapping layer 211 receives the first modal feature 201 as an input and obtains the first augmented feature 202 based on a first feature and a second query.

The electronic device may obtain a first query, the first key, and the first value from the first feature mapping layer 211 receiving the first modal feature 201. The first modal feature 201 may be a feature with height H, width W, and C channels in a real number space. The first feature mapping layer 211 may generate a new token matrix feature by flattening the first modal feature 201, aligning the order of the first modal feature 201, and adding a position encoding feature. The number of pixels of the token matrix feature is H×W and the number of channels is C in the real space. Through feature projection based on matrix multiplication, the first feature mapping layer 211 may generate token matrix features such as a first query (Q_{C}), a first key (K_{C}), and a first value (V_{C}), each of which has H×W pixels and C channels in the real number space. The electronic device may obtain a second query (Q_{L}) from the second feature mapping layer 221 receiving the second modal feature 203 as an input and obtain the first feature from the first attention layer 212 receiving the second query, the first key, and the first value as inputs.

The electronic device obtaining a first feature (Z_{C}) by performing a cross-attention operation on the second query, the first key, and the first value may be expressed by Equation 1 below.

$${Z}_{C} = Attention ( {Q}_{L} , {K}_{C} , {V}_{C} ) = softmax ( \frac{{Q}_{L} {K}_{C}^{T}}{\sqrt{C}} ) {V}_{C} \qquad Equation l$$

Attention (Q_{L}, K_{C}, V_{C}) represents an attention layer receiving the second query, the first key, and the first value, and the first feature may be a value obtained by multiplying a softmax function receiving V_{C}, Q_{L}, and

$${K}_{C}^{T}$$

by the first value (Q_{C}). \sqrt{C} represents the square root of the number of channels C, and K_{C}^{T} represents the transpose of the first key (K_{C}).

The first attention layer 212 may be based on a multi-head attention mechanism. In this case, the first feature (\hat{Z}_{C}) may be expressed by Equation 2 below, and an i-th attention layer may be expressed by Equation 3.

$${\hat{Z}}_{C} = Multihead ( {Q}_{L} , {K}_{C} , {V}_{C} ) = C o n c a t ( {Z}_{C}^{1} , … , {Z}_{C}^{h} ) W {1}^{O} {Z}_{C}^{i} = Attention ( {Q}_{L} W {1}_{i}^{q} , {K}_{C} W {1}_{i}^{k} , {V}_{C} W {1}_{i}^{v} ) , i ∈ \{ 1 , … h \} \qquad Equation 2$$

In Equation 2, Concat

$$( {Z}_{C}^{1} , … , {Z}_{C}^{h} )$$

may be a vector concatenation of

$${Z}_{C}^{1}$$

through

$${Z}_{C}^{h} .$$

W1^{O} with h×C rows and C channels in the real number space may be a weight.

In Equation 3, h represents the number of heads of a first multi-head attention layer.

$$W {1}_{i}^{q} , W {1}_{i}^{k} , and W {1}_{i}^{v}$$

are parameters of the i-th attention layer in the first multi-head attention layer and represent weights for a query, a key, and a value, respectively.

The first feature augmentation model 210 may further include a first normalization layer 213 and a first multi-layer perceptron layer 214. The electronic device may obtain a second feature from the first normalization layer 213 receiving (and performing inference on) the first feature and the second query as inputs, and then obtain a third feature from the first multi-layer perceptron layer 214 receiving the second feature as an input. The electronic device may obtain the first augmented feature 202 from a second normalization layer 215 receiving the second feature and the third feature as inputs and performing inference thereon. The first augmented feature 202 may be expressed by Equation 4 below.

$$M L P ( {F}_{2} ) + {F}_{2} \qquad Equation 4$$

F₂ represents the second feature obtained from the first normalization layer 213, MLP(F₂) represents the third feature obtained from the first multi-layer perceptron layer 214, and MLP(F₂)+F₂ represents the first augmented feature 202 obtained by normalizing the second feature and the third feature (which is obtained using the second normalization layer 215).

The second feature augmentation model 220 may include the second feature mapping layer 221 and a second attention layer 222. The electronic device may obtain a second key and a second value (which are used in the second attention layer 222) from the second feature mapping layer 221 receiving the second modal feature 203 as an input.

The electronic device may obtain the second query, the second key, and the second value from the second feature mapping layer 221 receiving the second modal feature 203 as an input. The second modal feature 203 may be a feature with height H, width W, and C channels in the real number space. The second feature mapping layer 221 may generate a new token matrix feature by flattening the second modal feature 203, aligning the order of the second modal feature 203, and adding a position encoding feature. A token matrix feature may have H×W pixels and C channels in the real space. Through feature projection based on matrix multiplication, the second feature mapping layer 221 may generate token matrix features such as a second query (Q_{L}), a second key (K_{L}), and a second value (V_{L}), each of which has H×W pixels C channels in the real number space. The electronic device may (i) obtain the first query (Q_{C}) from the first feature mapping layer 211 receiving the first modal feature 201 as an input and may (ii) obtain a fourth feature from the second attention layer 222 receiving the first query, the second key, and the second value as inputs. The obtaining of a fourth feature (Z_{L}) by performing a cross-attention operation on the first query, the second key, and the second value may be expressed by Equation 5 below.

$${Z}_{L} = Attention ( {Q}_{C} , {K}_{L} , {V}_{L} ) = softmax ( \frac{{Q}_{C} {K}_{L}^{T}}{\sqrt{C}} ) {V}_{L} \qquad Equation 5$$

Attention (Q_{L}, K_{C}, V_{C}) represents an attention layer receiving the first query, the second key, and the second value, and the fourth feature may be a value obtained by multiplying (i) a softmax function receiving \sqrt{C}, Q_{C} and

$${K}_{L}^{T}$$

by (ii) the second value (V_{L}). \sqrt{C} represents the square root of the number of channels C, and

$${K}_{L}^{T}$$

represents the transpose of the second key (K_{L}).

The second attention layer 222 may be based on the multi-head attention mechanism. In this case, the fourth feature (\hat{Z}_{L}) may be expressed by Equation 6 below, and the i-th attention layer may be expressed by Equation 7.

$${\hat{Z}}_{L} = Multihead ( {Q}_{C} , {K}_{L} , {V}_{L} ) = C o ncat ( {Z}_{L}^{1} , … , {Z}_{L}^{h} ) W {2}^{O} \qquad Equation 6$$

$${Z}_{L}^{i} = Attention ( {Q}_{C} W {2}_{i}^{q} , {K}_{L} W {2}_{i}^{k} , {V}_{L} W {2}_{i}^{v} ) , i ∈ \{ 1 , … h \} \qquad Equation 7$$

In Equation 6, Concat

$$( {Z}_{L}^{1} , … , {Z}_{L}^{h} )$$

may be a vector concatenation of

$${Z}_{L}^{1}$$

through

$${Z}_{L}^{h} .$$

And, W2^{O} with h×C rows and C channels in the real number space may be a weight.

In Equation 7, h represents the number of heads of a second multi-head attention layer

$$W {2}_{i}^{q} , W {2}_{i}^{k} , and W {2}_{i}^{v}$$

may be parameters of the i-th attention layer in the second multi-head attention layer and represent weights for a query, a key, and a value, respectively.

The second feature augmentation model 220 may further include a third normalization layer 223 and a second multi-layer perceptron layer 224. The electronic device may (i) obtain a fifth feature from the third normalization layer 223 receiving the fourth feature and the first query as inputs and (ii) obtain a sixth feature from the second multi-layer perceptron layer 224 receiving the fifth feature as an input. The electronic device may obtain the second augmented feature 204 from a fourth normalization layer 225 receiving the fifth feature and the sixth feature as inputs. The second augmented feature 204 may be expressed by Equation 8 below.

$$M L P ( {F}_{5} ) + {F}_{5} \qquad Equation 8$$

F₅ represents the fifth feature obtained from the third normalization layer 223, MLP(F₅) represents the sixth feature obtained from the second multi-layer perceptron layer 224, and MLP(F₅)+F₅ represents the first augmented feature 202 obtained by normalizing the fifth feature and the sixth feature obtained using the fourth normalization layer 225.

At least one of first to fourth neural networks of the first feature augmentation model 210 and the second feature augmentation model 220 may be omitted, and examples are not limited thereto.

The first feature augmentation model 210 may include first feature augmentation sub-models. For example, the electronic device may include the first feature augmentation model 210 including L (L is a positive integer) first feature augmentation sub-models and the second feature augmentation model 220. Each of the first feature augmentation sub-models may include its own instances of the first feature mapping layer 211, the first attention layer 212, the first normalization layer 213, and the first multi-layer perceptron layer 214. The first feature augmentation sub-models may be connected with one another in series. In the first feature augmentation sub-models, an output of a previous first feature augmentation sub-model and the second query obtained from the second feature mapping layer 221 of the second feature augmentation model 220 may be an input of a next first feature augmentation sub-model.

The electronic device may include the first feature augmentation model 210 including L first feature augmentation sub-models and the second feature augmentation model 220 including L second feature augmentation sub-models. Each of the second feature augmentation sub-models may include its own instances of the second feature mapping layer 221, the second attention layer 222, the third normalization layer 223, and the second multi-layer perceptron layer 224; the second feature augmentation sub-models may be connected with one another in series. The output of a previous first feature augmentation sub-model and the second query obtained from the second feature mapping layer 221 of a previous second feature augmentation sub-model may be the input of the next first feature augmentation sub-model. The previous first feature augmentation sub-model may correspond to the previous second feature augmentation sub-model.

The electronic device may include the second feature augmentation model 220 including L (L is a positive integer) second feature augmentation sub-models and the first feature augmentation model 210. Each of the second feature augmentation sub-models may include its own instances of the second feature mapping layer 221, the second attention layer 222, the third normalization layer 223, and the second multi-layer perceptron layer 224, and the second feature augmentation sub-models may be connected with one another in series. An output of a previous second feature augmentation sub-model and the first query obtained from the first feature mapping layer 221 of the first feature augmentation model 210 may be an input of a next second feature augmentation sub-model.

The electronic device may include the second feature augmentation model 220 including L second feature augmentation sub-models and the first feature augmentation model 210 including L first feature augmentation sub-models.

Each of the first feature augmentation sub-models may include its own instances of the first feature mapping layer 211, the first attention layer 212, the first normalization layer 213, and the first multi-layer perceptron layer 214, and the first feature augmentation sub-models may be connected with one another in series. The output of a previous second feature augmentation sub-model and the first query obtained from the first feature mapping layer 211 of the previous first feature augmentation sub-model may be the input of the next second feature augmentation sub-model, and a second feature augmentation sub-model may be a model corresponding to the previous first feature augmentation sub-model.

The number of feature augmentation models may depend on the number of modal features. For example, in the case of three modalities, in addition to the first feature augmentation model 210 and the second feature augmentation model 220, the electronic device may include a third feature augmentation model. In a cross-attention process, the electronic device may augment a modal feature (e.g., the first modal feature 201) based on, among the first modal feature 201, the second modal feature 203, and the third modal feature, either (i) referencing two different modal features (e.g., a query obtained from the second modal feature 203 and a query obtained from the third modal feature) or (ii) referencing only the other modal feature (e.g., a query obtained from the second modal feature 203 or a query obtained from the third modal feature).

Through the process described above, the electronic device may alleviate issues (e.g., low accuracy in map building) caused by information inconsistencies between different pieces of modal data resulting from the fusion of pieces of information of first modal data and second modal data.

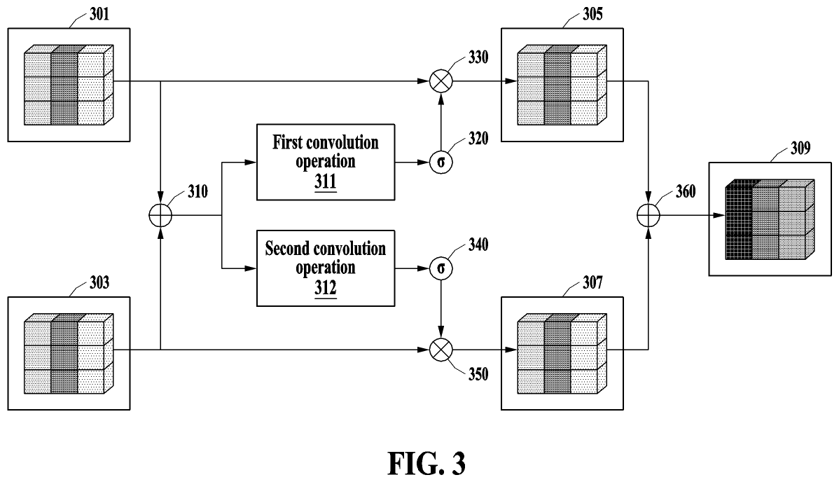

FIG. 3 illustrates an example of fusing augmented features, according to one or more embodiments.

Referring to FIG. 3, an electronic device (e.g., the electronic device 500 of FIG. 5) may obtain a fused feature 309 from a feature fusion model based on a first augmented feature 301 and a second augmented feature 303. The first augmented feature 301 may be a feature obtained by augmenting a first modal feature (e.g., the first modal feature 201 of FIG. 2), and the second augmented feature 303 may be a feature obtained by augmenting a second modal feature (e.g., the second modal feature 203 of FIG. 2).

The electronic device may obtain a cascaded feature by performing operation 310 of cascading the first augmented feature 301 and the second augmented feature 303.

The electronic device may obtain, from a feature augmentation model (e.g., the first feature augmentation model 210 of the second feature augmentation model 220 of FIG. 2) receiving the cascaded feature as an input, a feature extracted from the cascaded feature. The feature fusion model may perform a first convolution operation 311 (e.g., a convolution operation using a 3×3-sized kernel) on the input cascaded feature. The electronic device may input, to a first sigmoid function 320, the cascaded feature for which the first convolution operation 311 has been performed and obtain a first output feature value from the first sigmoid function 320. The electronic device may input, to a second sigmoid function 340, a cascaded feature for which a second convolution operation 312 has been performed and obtain a second output feature value from the second sigmoid function 340.

The electronic device may obtain sub-fused features (e.g., a first sub-fused feature 305 and a second sub-fused feature 307) that are used to generate a fused feature 309 based on an extracted feature (e.g., the first output feature value or the second feature value), the first augmented feature 301, and the second augmented feature 303. For example, the electronic device may obtain the first sub-fused feature 305 by operation 330 of performing an element-wise multiplication operation on the first augmented feature 301 and the first output feature value. The first augmented feature 301 and the first output feature value may be expressed in the form of a vector, a matrix, or a tensor. Performing an element-wise multiplication operation may involve multiplying corresponding components, for example, when the first augmented feature 301 and the first output feature value are expressed in the form of vectors. The electronic device may obtain the second sub-fused feature 307 using the second augmented feature 303 and the second output feature value obtained from the second sigmoid function. For example, the electronic device may obtain the second sub-fused feature 307 by performing an element-wise multiplication operation 350 on the second augmented feature 303 and the second output feature value.

The electronic device may obtain a fused feature 309 by performing operation 360 of cascading the sub-fused features (the first sub-fused feature 305 and the second sub-fused feature 307).

The feature augmentation model (including the first feature augmentation model 210 and the second feature augmentation model 220) may be trained through supervised learning, unsupervised learning, reinforcement learning, or the like, and examples are not limited thereto. The process of training a feature augmentation model may include, for example, preprocessing training data, detecting an augmented feature predicted from the feature augmentation model using the preprocessed training data, and updating parameters of the feature augmentation model using the detected augmented feature.

The training data used in the feature augmentation model may include training modal data and label data. Preprocessing the training data may include a normalization process to normalize the training modal data. Through the preprocessing process, the training modal data may be converted into a data format that may be more effectively utilized by the feature augmentation model.

The feature augmentation model may predict an augmented feature from a training modal feature using a feature mapping layer, an attention layer, a normalization layer, and a multi-layer perceptron layer. The process of optimizing the feature augmentation model may include determining a loss (or a loss function) for a predicted value output from the feature augmentation model and minimizing the determined loss. The process of minimizing the determined loss may include differentiating the loss function to determine how much each parameter of the feature augmentation model contributes to the loss and updating the parameters according to the degree of contribution. The updating of the parameters may use gradient descent or a technique modified from the gradient descent. Through this training process, the feature augmentation model may learn a pattern from a training modal feature and gain the ability to predict an augmented feature for a new modal feature.

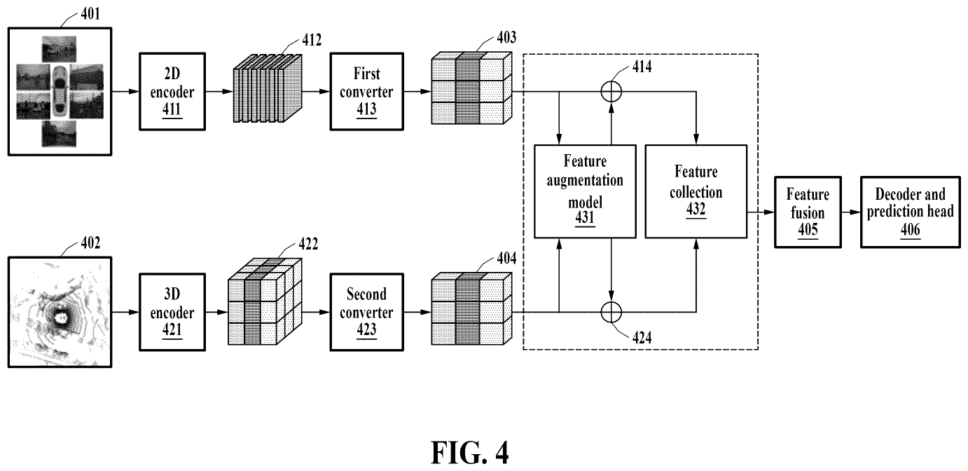

FIG. 4 illustrates an example in which an electronic device is used for map building, according to one or more embodiments.

Referring to FIG. 4, an electronic device (e.g., the electronic device 500 of FIG. 5) may build a map used for driving a vehicle using a multi-viewpoint RGB image 401 and a point cloud 402.

The electronic device may extract an image feature 412 from the multi-viewpoint RGB image 401 using a 2D encoder 411 and convert the extracted image feature 412 into the image feature 412 with a BEV using a first converter 413 (which is configured to convert image feature data from multi-viewpoint data to BEV data). The 2D encoder 411 may extract a feature from input data (e.g., image data). The 2D encoder 411 may be implemented using a convolutional neural network (CNN) model, a transformer model, or an autoencoder. For example, the electronic device may obtain the multi-viewpoint RGB image 401 from camera sensors equipped in the vehicle. The multi-viewpoint RGB image 401 may be color image data obtained using N cameras each having image height H^{cam} and image width W^{cam}. H^{cam} represents the height of the RGB image obtained by the electronic device using the camera sensor, and W^{cam} represents the width of the RGB image obtained by the electronic device using the camera sensor. In cases where sensors are of different dimensions, transforms may be used to obtain uniform-size multi-view images, or, the network/model may configured to receive multi-view inputs of different sizes.

As noted, the electronic device may extract a feature from the multi-viewpoint RGB image 401 using the 2D encoder 411. The electronic device may obtain a first modal feature 403 with a BEV using the first converter 413 that performs viewpoint conversion according to the viewpoint of the extracted feature (e.g., conversion to a perspective view from a viewpoint). The first converter 413 may obtain a perspective feature from the multi-viewpoint RGB image 401 and predict the depth at points distributed at equal intervals in the multi-viewpoint RGB image 401 (or all points) by performing a 2D convolution operation on the perspective feature. The perspective feature may be a feature that makes an object look different according to a distance, such as a perspective effect and a vanishing point, for the 2D RGB image. The electronic device may obtain a virtual point cloud feature with a dimension of D×H×W by allocating the perspective feature to D (corresponding to the number of emitted lights) points according to the directions of rays of light projected from the camera sensor. The electronic device may obtain the image feature 412 with a BEV including H×W×C pieces of data (the number of points included in a virtual point cloud) by flattening a virtual point cloud feature in a space seen from a BEV (e.g., a 2D projection). H denotes the height of the image feature 412 in the space seen from a BEV, W denotes the width of the image feature 412 in the space seen from a BEV, and C denotes a dimension of the virtual point cloud feature (e.g., color/channels).

The electronic device may extract a point cloud feature 422 from the point cloud 402 using a 3D encoder 421 and convert the extracted point cloud feature 422 into the point cloud feature 422 seen from a BEV using a second converter 423. The 3D encoder 421 may extract a feature from input data (e.g., the point cloud 402). The 3D encoder 421 may be implemented using a CNN model, a PointNet-based encoder, or a transformer-based 3D encoder. The point cloud 402 is a set of points representing the number of coordinates, 3D coordinates, reflectivity, and a ring index. The ring index may represent an index indicating the order (or number) of lights emitted by a LIDAR sensor to obtain the point cloud 402. For example, the electronic device may extract a feature of the point cloud 402 by voxelizing the point cloud 402 or sparsifying the point cloud 402 using the 3D encoder 421. The electronic device may obtain the point cloud feature 422 (including H×W×C points) seen from a BEV by flattening features of the point cloud 402. H denotes the height of the point cloud feature 422 in the space seen from a BEV, W denotes the width of the point cloud feature 422 in the space seen from a BEV, and C denotes a dimension of the point cloud feature (e.g., colors/channels).

The electronic device may input the first modal feature 403 and the second modal feature 404 to the feature augmentation model 431. The feature augmentation model 431 may perform interaction between the first modal feature 403 and the second modal feature 404 through cross attention. The feature augmentation model 431 may include a first feature augmentation model (e.g., the first feature augmentation model 210 of FIG. 2) and a second feature augmentation model (e.g., the second feature augmentation model 220 of FIG. 2). The interaction between the first modal feature 403 and the second modal feature 404 may involve the first modal feature 403 being augmented by the second modal feature 404 and the second modal feature 404 being augmented by the first modal feature 403. The electronic device may obtain, from the first feature augmentation model, a first augmented feature (e.g., the first augmented feature 202 of FIG. 2) obtained by augmenting the first modal feature 403 and a second augmented feature (e.g., the second augmented feature 204 of FIG. 2) obtained by augmenting the second modal feature 404. Obtaining the first augmented feature and the second augmented feature is described in detail with reference to FIG. 2.

The electronic device may generate a first cascaded feature by cascading the first modal feature 403 and the first augmented feature by performing cascade operation 414. The electronic device may generate a second cascaded feature by cascading the second modal feature 404 and the second augmented feature by performing cascade operation 424.

The electronic device may select, from among the first cascaded feature and the second cascaded feature, whichever feature is determined to be most useful for a target task (e.g., a map building task), and may perform the selecting by feature collection 432. The electronic device may select the useful feature for the target task based on a threshold value. For example, the electronic device may select whichever feature exceed the threshold value; when both the first cascaded feature and the second cascaded feature exceed the threshold value, the feature with a higher value may be selected. In the case of multiple sub-models, as described above, the most useful feature of each pair of sub-models may be selected.

The electronic device may obtain a fused feature (e.g., the fused feature 309 of FIG. 3) by performing feature fusion 405 operation on the features selected through the process described above. The electronic device may input the fused feature to a decoder and perform the target task (e.g., map building task) using a prediction head. For example, the decoder of the electronic device may generate output values for map elements to be included in a map using the fused feature, and the prediction head may output the final predicted values for the map elements using the output values for the map elements obtained from the decoder.

The electronic device may estimate the final predicted values for the map elements using a map element estimation model including the decoder and the prediction head. In this case, the final loss function used for training a map element estimation model may include a classification loss [symbol] , a point to point loss [symbol] , and an energy direction loss [symbol] . The final loss function may be expressed by Equation 9 below.

$$ℒ = {λ}_{1} {ℒ}_{c l s} + {λ}_{2} {ℒ}_{p 2 p} + {λ}_{3} \qquad Equation 9$$

Here, [symbol] represents the classification loss, [symbol] represents the point to point loss, and [symbol] represents the energy direction loss. λ₁, λ₂, and λ₃ represent hyperparameters to balance the three losses (the classification loss, the point to point loss, and the energy direction loss). The map element estimation model may gain the ability to predict map elements more accurately by being trained to minimize the value of [symbol] (the final loss function).

Although some of the description above is in the form of mathematical notation, such mathematical notation is only shorthand description for equivalent description by words. Given the mathematical notation, and other information disclosed herein, an engineer or developer may craft source code, for example, that parallels the mathematical descriptions. Such source code may be compiled into processor-executable instructions that, when executed by one or more processors, perform operations analogous to those described by the mathematical notation (and other description).

In addition, for conciseness, various pieces of data (e.g., features) are described as being inputs and outputs to/from various modules/models (or similar components), or as being “used in” various components. For example, the first feature (see FIG. 2, for example) is described as being an output of one layer (e.g., first attention layer 212) and an input to another layer (e.g., first normalization layer 213). Context permitting, such a piece of data described as input/output to/from a given component may nonetheless have additional processing/transformation performed thereon and still be considered to have identity with (i.e., be) the piece of data inputted/outputted to/from the given component (e.g., model or module). For example, an image feature may still be deemed to be the same image feature even if it is resized, filtered, compressed, or the like. For example, an “input” to a given layer/model may have some intermediate processing performed thereon before being inputted to (or “used in”) the one layer. An output from a given layer/model may have some processing performed thereon and still be considered to be output from the given layer/model.

FIG. 5 illustrates an example of components of an electronic device, according to one or more embodiments.

Referring to FIG. 5, the electronic device 500 may include a memory 510 and a processor 520. The electronic device 500 may correspond to any of the electronic devices described herein.

The memory 510 may store instructions executable by the processor 520. When executed by the processor 520, the instructions executable by the processor 520 may cause the processor 520 to perform a method. The memory 510 may be integrated with the processor 520. For example, random-access memory (RAM) or flash memory may be integrated with the processor 520 such as an integrated circuit microprocessor. The memory 510 may include a separate device, such as a storage device that may be used by an external disk drive, a storage array, or a database system. The memory 510 and the processor 520 may be operatively integrated or may communicate with each other via an input/output (I/O) port, a network connection, or the like so that the processor 520 may read a file stored in the memory 510. The memory 510 may be a non-transitory computer-readable storage medium that stores instructions. When executed by the processor 520, the instructions stored in the memory 510 may prompt at least one processor 520 to cause the electronic device 500 to perform the method.

The non-transitory computer-readable storage medium may include read-only memory (ROM), programmable ROM (PROM), electrically erasable PROM (EEPROM), RAM, dynamic RAM (DRAM), static RAM (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, BLU-RAY or optical disk memory, a hard disk drive (HDD), a solid state drive (SSD), card memory (e.g., a multimedia card, a secure digital (SD) card, or an extreme digital (XD) card), magnetic tape, a floppy disk, a magneto-optical data storage device, an optical data storage device, a hard disk, a solid state disk, and other devices.

The processor 520 may execute the instructions stored in the memory 510. The processor 520 may include a central processing unit (CPU), a graphics processing unit (GPU), a neural network processing unit (NPU), a media processing unit (MPU), a data processing unit (DPU), a vision processing unit (VPU), a video processor, an image processor, a display processor, a microprocessor, a processor core, a multi-core processor, an application-specific integrated circuit (ASIC), a field programmable gate array (FPGA), or any combination thereof. When the instructions are executed by the processor 520, the processor 520 may control the electronic device 500 to perform operations of the method described in the present disclosure.

The electronic device 500 according to an embodiment may obtain a first modal feature extracted from an image obtained through a first sensor and a second modal feature extracted from a point cloud obtained through a second sensor (of a type/modality that is different than that of the first sensor), obtain a first augmented feature by performing feature augmentation processing on the first modal feature using the second modal feature, obtain a second augmented feature by performing feature augmentation processing on the second modal feature using the first modal feature, obtain a fused feature by fusing the first augmented feature with the second augmented feature, and perform a target task using the obtained fused feature.

The electronic device 500 may obtain, from a first feature augmentation model, the first augmented feature by augmenting the first modal feature, wherein the first feature augmentation model receives, as inputs, the first modal feature and a second query, which is obtained from a second feature mapping layer of a second feature augmentation model, and obtain, from the second feature augmentation model, the second augmented feature by augmenting the second modal feature, wherein the second feature augmentation model receives, as inputs, the second modal feature and a first query, which is output from a first feature mapping layer of the first feature augmentation model.

The first feature augmentation model may include the first feature mapping layer that extracts an input of a first attention layer from the first modal feature and the first attention layer that outputs a feature based on the first modal feature and the second modal feature. The electronic device 500 may obtain, from the first feature mapping layer receiving the first modal feature as an input, a first key and a first value that are used in the first attention layer, obtain the second query from the second feature mapping layer receiving the second modal feature as an input, obtain a first feature from the first attention layer receiving the second query, the first key, and the first value as inputs, and obtain the first augmented feature based on the first feature and the second query.

The first feature augmentation model may further include a first normalization layer that normalizes an output of the first attention layer and a first multi-layer perceptron layer connected with the first normalization layer. The electronic device 500 may obtain a second feature from the first normalization layer receiving the first feature and the second query as inputs, obtain a third feature from the first multi-layer perceptron layer receiving the second feature as an input, and obtain the first augmented feature from a second normalization layer receiving the second feature and the third feature as inputs.

The second feature augmentation model may include the second feature mapping layer that extracts an input of a second attention layer from the second modal feature and the second attention layer that outputs a feature based on the second modal feature and the first modal feature. The electronic device 500 may obtain, from the second feature mapping layer receiving the second modal feature as an input, a second key and a second value that are used in the second attention layer, obtain the first query from the first feature mapping layer receiving the first modal feature as an input, obtain a fourth feature from the second attention layer receiving the first query, the second key, and the second value as inputs, and obtain the second augmented feature based on the fourth feature and the first query.

The second feature augmentation model may further include the third normalization layer that normalizes the output of the second attention layer and the second multi-layer perceptron layer connected with the third normalization layer. The electronic device 500 may obtain a fifth feature from a third normalization layer receiving the fourth feature and the first query as inputs, obtain a sixth feature from the second multi-layer perceptron layer receiving the fifth feature as an input, and obtain the second augmented feature from a fourth normalization layer receiving the fifth feature and the sixth feature as inputs.

The electronic device 500 may obtain a fused feature from a feature fusion model based on the first augmented feature and the second augmented feature.

The electronic device 500 may (i) obtain a cascaded feature by cascading the first augmented feature and the second augmented feature, (ii) obtain, from the feature fusion model receiving the cascaded feature as an input, a feature extracted from the cascaded feature, (iii) obtain sub-fused features that are used to generate a fused feature based on the extracted feature, the first augmented feature, and the second augmented feature, and (iv) obtain the fused feature by cascading the sub-fused features.

FIG. 6 illustrates an example of connections between components of an electronic device, according to one or more embodiments.

Referring to FIG. 6, an electronic device 600 may include a memory 610, a processor 620, a transceiver 630, and a bus 640. The electronic device 600 may correspond to the electronic device 500 of FIG. 5. The electronic device 600 may receive, through the transceiver 630, a request for a target task or receive, through the transceiver 630, an image (e.g., an image obtained through a camera sensor) for performing the target task and/or a point cloud (e.g., a point cloud obtained through a LIDAR sensor). The electronic device 600 may transmit the received target task, the received image, and/or the point cloud to the processor 620 via the bus 640 to perform the target task. The electronic device 600 may transmit a program 611 (or instructions) required to perform the target task from the memory 610 to the processor 620 via the bus 640.

The memory 610 may correspond to the memory 510 of FIG. 5, and the program 611 stored in the memory 610 may correspond to the instructions executable by the processor 520 stored in the memory 510. Thus, hereinafter, any repeated description related thereto is omitted.

The processor 620 may be the processor 520 of FIG. 5.

The transceiver 630 may enable the electronic device 600 and an external electronic device (e.g., an external vehicle system with a communication function) to communicate using a communication channel or a wireless communication channel. The transceiver 630 may include a communication circuit (not shown) for communication. The transceiver 630 may operate independently of the processor 620 and may include one or more communication processors that support direct (e.g., wired) communication or wireless communication. The transceiver 630 may be implemented as a single chip or as a plurality of chips. The transceiver 630 may receive a request to perform a target task (e.g., a map building task) using the electronic device 600.

The bus 640 may transfer data between the memory 610, the processor 620, and the transceiver 630. The bus 640 may be a peripheral component interconnect (PCI) bus or an extended industry standard architecture (EISA) bus. The bus 640 may include an address bus, a data bus, a control bus, and the like. The bus 640 may include one or more lines or one or more types of lines for data movement between the memory 610, the processor 620, and the transceiver 630, and examples are not limited thereto.

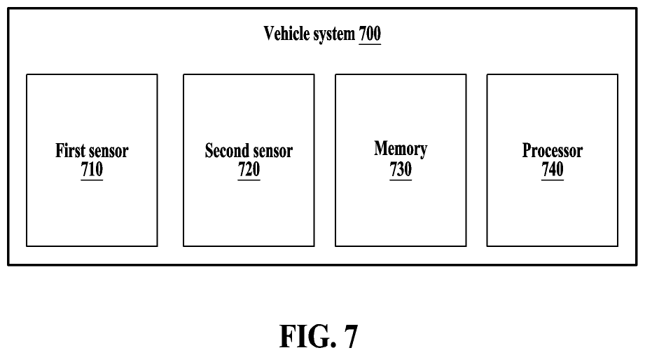

FIG. 7 illustrates an example of a vehicle system using an electronic device, according to one or more embodiments.

Referring to FIG. 7, a vehicle system 700 may be installed as part of a may include a first sensor 710, a second sensor 720, a memory 730, and a processor 740. The memory 730 may correspond to the memory 510 of the electronic device 500 of FIG. 5, and the processor 740 may correspond to the processor 520 of the electronic device 500 of FIG. 5.

The first sensor 710 may obtain an image of a target zone for map building. The first sensor 710 may be a camera, and the camera may obtain the image of the target zone for map building. The camera may include a mobile mapping camera, a panoramic camera, and the like, and examples are not limited thereto. Nor are examples limited to vehicular applications or map generation.

The second sensor 720 may obtain a point cloud of the target zone. The second sensor 720 may be a LiDAR sensor, for example, and the LiDAR sensor may obtain the point cloud of the target zone for map building. The second sensor 720 may include an RGB-depth (D) camera, a stereo camera, and the like in addition to the LiDAR sensor, and examples are not limited thereto. For example, the second sensor 720 may be a radar a camera with a depth sensor, or the like.

The memory 730 may store instructions executable by the processor 740. When executed by the processor 740, the instructions executable by the processor 740 may cause the processor 740 to perform a method. The memory 730 may be integrated with the processor 740. For example, RAM or flash memory may be integrated with the processor 740 such as an integrated circuit microprocessor. The memory 730 may include a separate device, such as a storage device that may be used by an external disk drive, a storage array, or a database system. The memory 730 and the processor 740 may be operatively integrated or may communicate with each other via an I/O port, a network connection, or the like so that the processor 740 may read a file stored in the memory 730. The memory 730 may be a non-transitory computer-readable storage medium that stores instructions. When executed by the processor 740, the instructions stored in the memory 730 may prompt at least one processor 740 to cause the vehicle system 700 to perform the method.

The non-transitory computer-readable storage medium may include ROM, PROM, EEPROM, RAM, DRAM, SRAM, flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, BLU-RAY or optical disk memory, an HDD, an SSD, card memory (e.g., a multimedia card, an SD card, or an XD card), magnetic tape, a floppy disk, a magneto-optical data storage device, an optical data storage device, a hard disk, a solid state disk, and other devices.

The processor 740 may execute the instructions stored in the memory 730. The processor 740 may include a CPU, a GPU, an NPU, an MPU, a DPU, a VPU, a video processor, an image processor, a display processor, a microprocessor, a processor core, a multi-core processor, an ASIC, a FPGA, or any combination thereof. When the instructions are executed by the processor 740, the processor 740 may control the vehicle system 700 to perform operations of the method described in the present disclosure.

The vehicle system 700 according to an embodiment may obtain a first modal feature indicating a feature extracted from an image obtained through the first sensor 710 and a second modal feature indicating a feature extracted from a point cloud obtained through the second sensor 720 that is different from the first sensor 710. The vehicle system 700 may obtain a first augmented feature by performing feature augmentation processing on the first modal feature using the second modal feature and obtain a second augmented feature by performing feature augmentation processing on the second modal feature using the first modal feature. The vehicle system 700 may obtain a fused feature by fusing the first augmented feature with the second augmented feature and perform a target task using the obtained fused feature.

The vehicle system 700 may obtain, from a first feature augmentation model, the first augmented feature by augmenting the first modal feature, wherein the first feature augmentation model receives, as inputs, the first modal feature and a second query, which is obtained from a second feature mapping layer of a second feature augmentation model and obtain, from the second feature augmentation model, the second augmented feature by augmenting the second modal feature, wherein the second feature augmentation model receives, as inputs, the second modal feature and a first query, which is output from the first feature mapping layer of the first feature augmentation model.

The computing apparatuses, the electronic devices, the processors, the memories, the displays, the information output system and hardware, the storage devices, and other apparatuses, devices, units, modules, and components described herein, including descriptions with respect to respect to FIGS. 1-7, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-7 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic device comprising:
one or more processors;
a memory storing instructions configured to, when executed by the one or more processors, cause the electronic device to:
obtain a first modal feature extracted from an image obtained through one or more first sensors and obtain a second modal feature extracted from a point cloud obtained through a second sensor that has a different modality than that of the one or more first sensors;
obtain a first augmented feature by performing feature augmentation processing on the first modal feature using the second modal feature and obtain a second augmented feature by performing feature augmentation processing on the second modal feature using the first modal feature;
obtain a fused feature by fusing the first augmented feature with the second augmented feature; and
perform a target task using the obtained fused feature.

2. The electronic device of claim 1, wherein, the instructions are further configured to cause the electronic device to:
obtain, from a first feature augmentation model, the first augmented feature by augmenting the first modal feature, wherein the first feature augmentation model receives, as inputs, the first modal feature and a second query, which is obtained from a second feature mapping layer of a second feature augmentation model; and
obtain, from the second feature augmentation model, the second augmented feature by augmenting the second modal feature, wherein the second feature augmentation model receives, as inputs, the second modal feature and a first query, which is output from a first feature mapping layer of the first feature augmentation model.

3. The electronic device of claim 2, wherein
the first feature augmentation model comprises:
the first feature mapping layer configured to extract, from the first modal feature, an input of a first attention layer; and
the first attention layer configured to output a feature based on the first modal feature and the second modal feature, and
wherein the instructions are further configured to cause the electronic device to:
obtain, from the first feature mapping layer receiving the first modal feature as an input, a first key and a first value that are used in the first attention layer;
obtain the second query from the second feature mapping layer receiving the second modal feature as an input;
obtain a first feature from the first attention layer receiving the second query, the first key, and the first value as inputs; and
obtain the first augmented feature based on the first feature and the second query.

4. The electronic device of claim 3, wherein
the first feature augmentation model further comprises:
a first normalization layer configured to normalize an output of the first attention layer; and
a first multi-layer perceptron layer connected with the first normalization layer, and
wherein the instructions are further configured to cause the electronic device to:
obtain a second feature from the first normalization layer receiving the first feature and the second query as inputs;
obtain a third feature from the first multi-layer perceptron layer receiving the second feature as an input; and
obtain the first augmented feature from a second normalization layer receiving the second feature and the third feature as inputs.

5. The electronic device of claim 2, wherein
the second feature augmentation model comprises:
a second feature mapping layer configured to extract, from the second modal feature, an input of a second attention layer; and
the second attention layer configured to output a feature based on the second modal feature and the first modal feature, and
wherein the instructions are further configured to cause the electronic device to:
obtain, from the second feature mapping layer receiving the second modal feature as an input, a second key and a second value that are used in the second attention layer;
obtain the first query from the first feature mapping layer receiving the first modal feature as an input;
obtain a fourth feature from the second attention layer receiving the first query, the second key, and the second value as inputs; and
obtain the second augmented feature based on the fourth feature and the first query.

6. The electronic device of claim 5, wherein
the second feature augmentation model further comprises:
a third normalization layer configured to normalize an output of the second attention layer; and
a second multi-layer perceptron layer connected with the third normalization layer, and
wherein the instructions are further configured to cause the electronic device to:
obtain a fifth feature from the third normalization layer receiving the fourth feature and the first query as inputs;
obtain a sixth feature from the second multi-layer perceptron layer receiving the fifth feature as an input; and
obtain the second augmented feature from a fourth normalization layer receiving the fifth feature and the sixth feature as inputs.

7. The electronic device of claim 4, wherein
the first feature augmentation model comprises first feature augmentation sub-models,
each of the first feature augmentation sub-models comprises an instance of the first feature mapping layer, an instance of the first attention layer, an instance of the first normalization layer, and an instance of the first multi-layer perceptron layer,
the first feature augmentation sub-models are connected with one another in series, and
both an output of a given first feature augmentation sub-model and the second query obtained from the second feature mapping layer of the second feature augmentation model are an input of a next first feature augmentation sub-model after the given first feature augmentation sub-model.

8. The electronic device of claim 7, wherein
the second feature augmentation model comprises second feature augmentation sub-models,
each of the second feature augmentation sub-models comprises an instance of the second feature mapping layer, an instance of a second attention layer, an instance of a third normalization layer, and an instance of a second multi-layer perceptron layer,
the second feature augmentation sub-models are connected with one another in series,
an output of the given first feature augmentation sub-model and a second query obtained from the second feature mapping layer of a previous second feature augmentation sub-model are an input of the next first feature augmentation sub-model, and
the given first feature augmentation sub-model is a model corresponding to the previous second feature augmentation sub-model.

9. The electronic device of claim 6, wherein
the second feature augmentation model comprises second feature augmentation sub-models,
each of the second feature augmentation sub-models comprises an instance of the second feature mapping layer, an instance of the second attention layer, an instance of the third normalization layer, and an instance of the second multi-layer perceptron layer,
the second feature augmentation sub-models are connected with one another in series, and
an output of a previous second feature augmentation sub-model and the first query obtained from the first feature mapping layer of the first feature augmentation model are an input of a next second feature augmentation sub-model.

10. The electronic device of claim 9, wherein
the first feature augmentation model comprises first feature augmentation sub-models,
each of the first feature augmentation sub-models comprises an instance of the first feature mapping layer, an instance of a first attention layer, an instance of a first normalization layer, and an instance of a first multi-layer perceptron layer,
the first feature augmentation sub-models are connected with one another in series,
an output of the previous second feature augmentation sub-model and a first query obtained from the first feature mapping layer of a previous first feature augmentation sub-model are an input of a next second feature augmentation sub-model, and
the previous second feature augmentation sub-model is a model corresponding to the previous first feature augmentation sub-model.

11. The electronic device of claim 2, wherein
a first attention layer of the first feature augmentation model comprises a multi-head attention mechanism, and
a second attention layer of the second feature augmentation model comprises a multi-head attention mechanism.

12. The electronic device of claim 1, wherein, the instructions are further configured to cause the electronic device to obtain the fused feature from a feature fusion model based on the first augmented feature and the second augmented feature.

13. The electronic device of claim 12, wherein,
the instructions are further configured to cause the electronic device to:
obtain a cascaded feature by cascading the first augmented feature and the second augmented feature;
obtain, from the feature fusion model receiving the cascaded feature as an input, a feature extracted from the cascaded feature;
obtain sub-fused features that are used to generate the fused feature based on the extracted feature, the first augmented feature, and the second augmented feature; and
obtain the fused feature by cascading the sub-fused features.

14. The electronic device of claim 1, wherein
the one or more first sensors are one or more camera sensors, and
the second sensor is a light detection and ranging (LiDAR) sensor.

15. A method executed by an electronic device, the method comprising:
obtaining a first modal feature extracted from an image obtained through one or more first sensors and obtaining a second modal feature extracted from a point cloud obtained through a second sensor that has different modality that that of the one or more first sensors;
obtaining a first augmented feature by performing feature augmentation processing on the first modal feature using the second modal feature;
obtaining a second augmented feature by performing feature augmentation processing on the second modal feature using the first modal feature;
obtaining a fused feature by fusing the first augmented feature with the second augmented feature; and
performing a target task using the obtained fused feature.

16. The method of claim 15, wherein
the obtaining of the first augmented feature comprises obtaining, from a first feature augmentation model, the first augmented feature by augmenting the first modal feature, wherein the first feature augmentation model receives, as inputs, the first modal feature and a second query, which is obtained from a second feature mapping layer of a second feature augmentation model, and
the obtaining of the second augmented feature comprises obtaining, from a second feature augmentation model, the second augmented feature by augmenting the second modal feature, wherein the second feature augmentation model receives, as inputs, a first query, which is output from a first feature mapping layer of the first feature augmentation model, and the second modal feature.

17. The method of claim 16, wherein
the first feature augmentation model comprises:
the first feature mapping layer configured to extract, from the first modal feature, an input of a first attention layer; and
the first attention layer configured to output a feature based on the first modal feature and the second modal feature, and
wherein the obtaining of the first augmented feature comprises:
obtaining, from the first feature mapping layer receiving the first modal feature as an input, a first key and a first value that are used in the first attention layer;
obtaining the second query from the second feature mapping layer receiving the second modal feature as an input;
obtaining a first feature from the first attention layer receiving the second query, the first key, and the first value as inputs; and
obtaining the first augmented feature based on the first feature and the second query.

18. The method of claim 16, wherein
the second feature augmentation model comprises:
a second feature mapping layer configured to extract, from the second modal feature, an input of a second attention layer; and
the second attention layer configured to output a feature based on the second modal feature and the first modal feature, and
the obtaining of the second augmented feature comprises:
obtaining, from the second feature mapping layer receiving the second modal feature as an input, a second key and a second value that are used in the second attention layer;
obtaining the first query from a first feature mapping layer receiving the first modal feature as an input;
obtaining a fourth feature from the second attention layer receiving the first query, the second key, and the second value as inputs; and
obtaining the second augmented feature based on the fourth feature and the first query.

19. A vehicle system comprising:
one or more first sensors configured to obtain an image of a target zone;
a second sensor configured to obtain a point cloud for the target zone;
a memory in which instructions are stored; and
one or more processor configured to execute the instructions stored in the memory,
wherein the instructions, when executed by the one or more processors, cause the vehicle system to:
obtain a first modal feature extracted from an image obtained through the one or more first sensors and obtain a second modal feature extracted from a point cloud obtained through the second sensor that has a different modality than that of the one or more first sensors;
obtain a first augmented feature by performing feature augmentation processing on the first modal feature using the second modal feature and obtain a second augmented feature by performing feature augmentation processing on the second modal feature using the first modal feature;
obtain a fused feature by fusing the first augmented feature with the second augmented feature; and
control the vehicle system to perform a target task using the obtained fused feature.

20. The vehicle system of claim 19, wherein the instructions, when executed by the one or more processors, cause the vehicle system to:
obtain, from a first feature augmentation model, the first augmented feature by augmenting the first modal feature, wherein the first feature augmentation model receives, as inputs, the first modal feature and a second query, which is obtained from a second feature mapping layer of a second feature augmentation model; and
control the vehicle system to obtain, from a second feature augmentation model, the second augmented feature by augmenting the second modal feature, wherein the second feature augmentation model receives, as inputs, a first query, which is output from a first feature mapping layer of the first feature augmentation model, and the second modal feature.
